(19) United States
(12) Patent Application Publication
(10) Pub. No.: US 2016/0049097 A1
(43) Pub. Date: Feb. 18, 2016

(54) SYSTEMS AND METHODS FOR DETERMINING AN INTERVENTION TO IMPROVE USE OF UPPER LIMB PROSTHESIS

(71) Applicant: Advanced Arm Dynamics, Inc., Redondo Beach, CA (US)

(72) Inventors: Kerstin Baun, Lake Oswego, OR (US); Christopher James Bollinger, Philadelphia, PA (US); Dan Conyers, Beaverton, OR (US); Chih-Ying Janice Hsu, Lakewood, OH (US); Warren T. Jackson, Grapevine, TX (US); John M. Miguelez, Palos Verdes Estates, CA (US); Jennifer K. Peterson, Delano, MN (US); Kasey Rogner Pool, Richardson, TX (US); Tiffany Ryan, Arlington, TX (US); Joby Varghese, Carrollton, TX (US); Lisa Smurr Walters, Rosharon, TX (US)

(21) Appl. No.: 14/828,208

(22) Filed: Aug. 17, 2015

Related U.S. Application Data
(60) Provisional application No. 62/038,145, filed on Aug. 15, 2014.

(51) Int. Cl. G09B 23/28

(52) U.S. Cl. CPC G09B 23/28

(57) ABSTRACT

A method for determining an intervention to improve use of upper limb prosthesis which includes instructing a person having an upper limb prosthesis to perform a plurality of tasks, including but not limited to, using the prosthesis in multiple planes, using the prosthesis with a plurality of grasp patterns, using the prosthesis at various distances from the body, using the prosthesis in unilateral and bilateral tasks, and using the prosthesis while the person is arranged in various positions. The method further includes, for each of the plurality of tasks, determining a category score for categories comprising control skills, component feature utilization, compensatory movement, and task completion, and obtaining a cumulative category score for each of the categories based on the category score for each of the plurality of tasks. The method further includes determining an intervention for improving use of the upper limb prosthesis based on at least the cumulative category score for each of the categories.

### STATEMENT OF PRIORITY

The present application claims priority to U.S. Provisional Application No. 62/038,145, titled “Systems and Methods for Determining Upper Limb Prosthesis Performance” and filed Aug. 15, 2014.

### TECHNICAL FIELD

The present disclosure relates to systems and methods for determining an intervention to improve use of upper limb prosthesis.

### BACKGROUND

Currently, there is not an industry standard measure to inform prescriptive prosthetic decisions for a person with an upper limb (UL) amputation. In determining the proper prosthesis for a person or necessary prosthetic rehabilitation, various tests are typically run which measure general areas of functionality. One downside to this is these tests are often generalized to upper limb injury or one area of prosthetic performance. Another downside is that there is no single all-inclusive (or near all-inclusive) test, thus requiring numerous tests which increases testing time, increases burden on the patient, and decreases efficiency in upper limb prosthesis care.

Proper tests are important, not only to obtain the proper fit and increase functionality in highly used areas, but they serve additional needs and requirements related to long-term care. For example, current tests are typically instantaneous and typically fail to measure effectiveness of selected intervention and patient care over periods of time. Moreover, such test results are important due to effecting insurance claims and possible referrals. Furthermore, such test results over time are needed to assist and guide prosthetists in prosthesis design and component selection to meet patient individual needs and therapists with intervention and therapy for the patient. There are only a few measures validated for upper limb prosthesis users and they do not measure a majority of the factors influencing prosthesis user performance.

Therefore, there remains a need for better performance assessments for UL prosthesis users, such as tests which require minimal patient testing time while providing maximum results with regard to at least the areas mentioned above.

### SUMMARY OF THE INVENTION

The present disclosure introduces various illustrative embodiments for systems and methods for determining an intervention to improve use of upper limb prosthesis.

It is an object of the present disclosure to provide a method for determining an intervention to improve use of upper limb prosthesis which includes instructing a person having an upper limb prosthesis to perform a plurality of tasks, including but not limited to, using the prosthesis in multiple planes, using the prosthesis with a plurality of grasp patterns, using the prosthesis at various distances from the body, using the prosthesis in unilateral and bilateral tasks, and using the prosthesis while the person is arranged in various positions. The method further includes, for each of the plurality of tasks, determining a category score for categories comprising control skills, component feature utilization, compensatory movement, and task completion, and obtaining a cumulative category score for each of said categories based on said category score for each of said plurality of tasks. The method further includes determining intervention means for improving use of said upper limb prosthesis based on at least said cumulative category score for each of said categories.

It is another object of the present disclosure to provide a system for determining an intervention to improve use of upper limb prosthesis that includes task means for performing a plurality of tasks which test the ability of a person having an upper limb prosthesis to use said upper limb prosthesis in multiple planes, with a plurality of grasp patterns, at various distances from the body, in performing unilateral and bilateral tasks, and while said person is arranged in various positions. The system further includes category scoring means for determining a category score for categories comprising control skills, component feature utilization, compensatory movement, and task completion, said category score for said categories being determined for each of said plurality of tasks. The system further includes intervention determination means for determining an intervention to improve use of said upper limb prosthesis based on at least a cumulative category score of each of said categories.

Although the disclosure has been described and illustrated with respect to exemplary objects thereof, it will be understood by those skilled in the art that various other changes, omissions, and additions may be made therein and thereto without departing from the scope of the present disclosure.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIGS. 1A-1I depict objects used in various prosthesis tests, according to one or more embodiments.

FIG. 2 is a diagram depicting factors associated with scoring criteria for each task, according to one or more embodiments.

FIG. 3 is a flow diagram of a method for measuring performance with a prosthesis, according to one or more embodiments.

### DETAILED DESCRIPTION

The present disclosure relates to systems and methods for determining an intervention to improve use of upper limb (UL) prosthesis. In some embodiments, one or more tasks may be performed which employ various daily objects to perform routine tasks. Thus, such tasks include use of the prosthesis in multiple planes, with a plurality of grasp patterns, in various distances from the body, requiring both unilateral and bilateral movements, and being performed while the person is in various positions, all of which being described in further detail below. For each of the tasks, a score is determined for various categories, including but not limited to, control skills, component feature utilization, compensatory movement, and task completion. An overall cumulative score is further determined for each category based on the category score for each task. Thereafter, an intervention can be determined based on the cumulative scores for each category. In general, exemplary interventions may include fit of the prosthetic on the person, design and components of the prosthesis in comparison to what the persons may use most in daily life, and the person's skill with the prosthesis are measured and/or incorporated into evaluation of the prosthesis

Advantageously, the tasks described herein enable evaluation of numerous factors, thereby enabling reduction in the number of overall tests, and thus also a reduction in testing time required to determine the proper intervention.

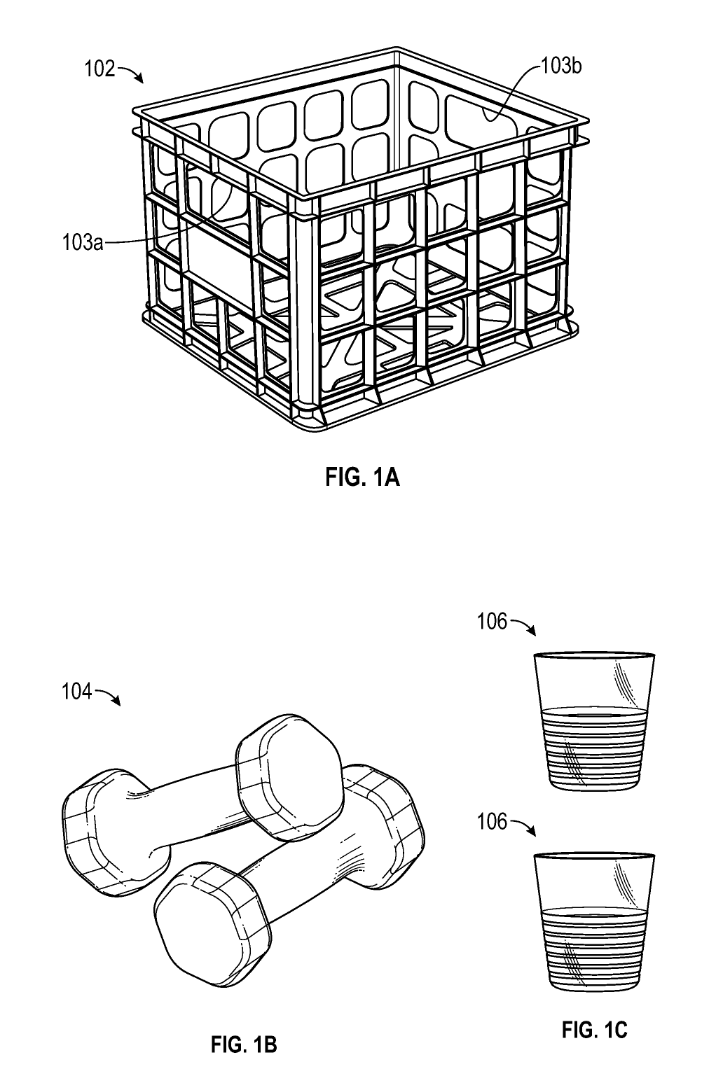

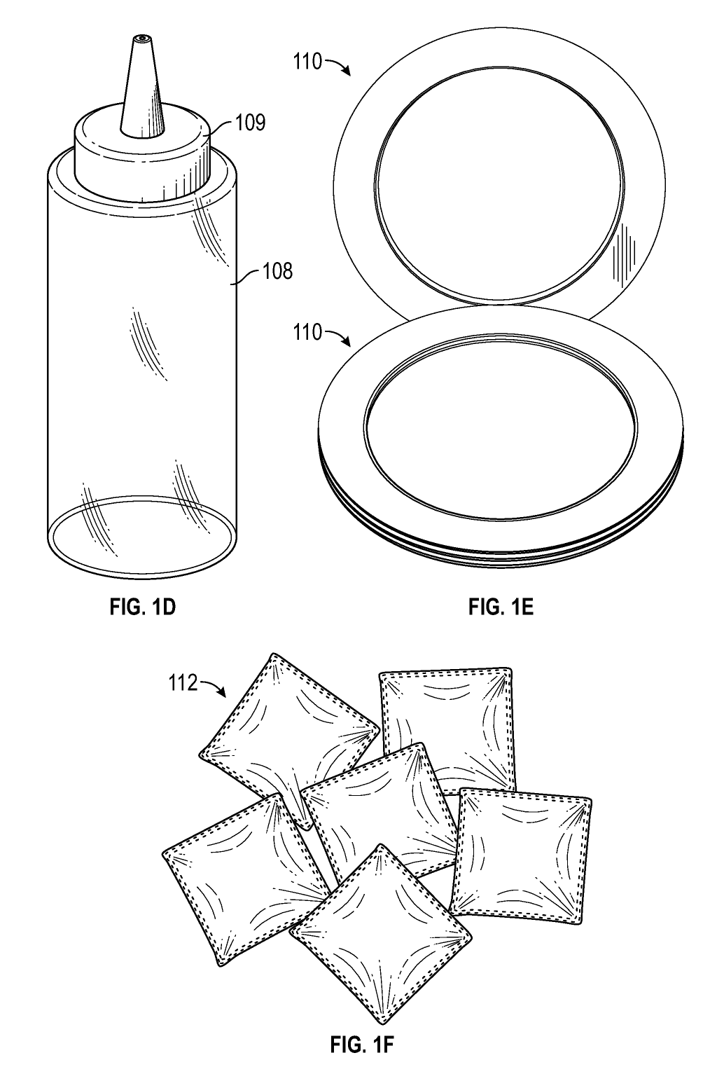

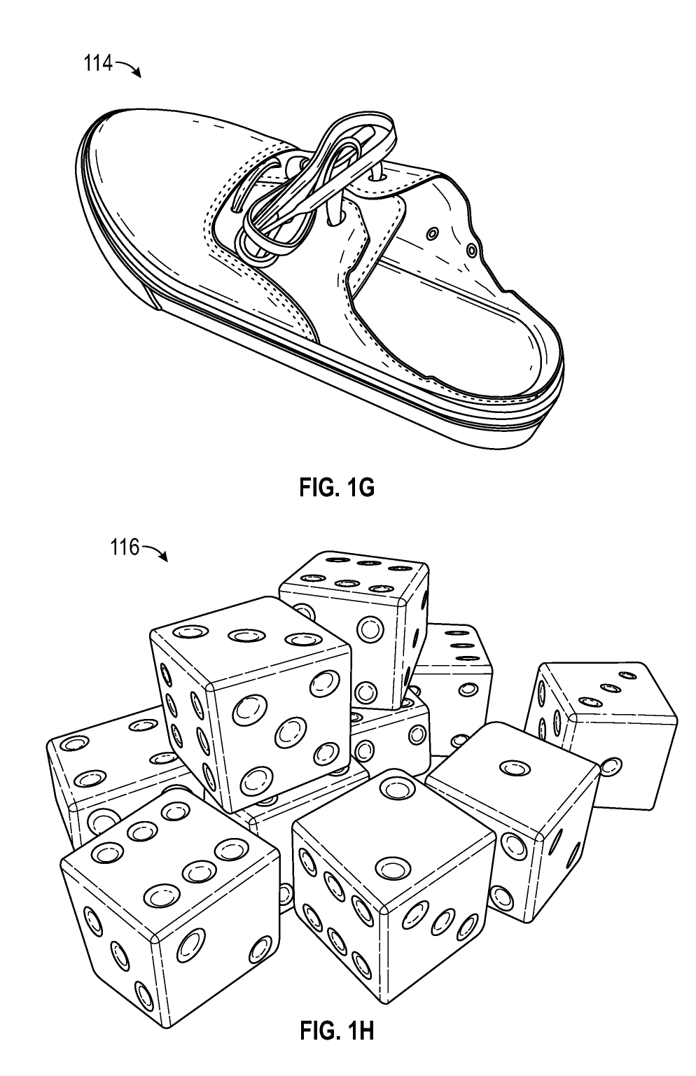

FIGS. 1A-1I depict task means, or objects that may be used to perform various tasks which test prosthetics in relationship to movements performed during daily routines, according to one or more embodiments. For example, FIG. 1A represents a first container (depicted as a crate) 102 which includes a hollow area therein. In some embodiments, the first container 102 may include a pair of handles 103a,b (depicted as a first handle 103a and a second handle 103b). Thus, the first container 102 may be used to have a person place objects therein and/or to move the first container 102, and any objects place therein, from one location to another via the handles 103a,b. FIG. 1B depicts weights 104 which a patient may be tasked to move locations, and/or place on or within objects, for example being placed within the first container 102. In some embodiments, the weight 104 may weigh, for example, 2 pounds (lbs). In other embodiments, the weight 104 may be more or less than 2 lbs.

FIG. 1C depicts cups representing a second container 106 which the patient may be required to pick up or pour a liquid into, for example from a third container 108 (FIG. 1D), depicted as a bottle. In some embodiments, the third container 108 includes a top 109 coupled thereto which substantially prevents removal of fluid within the third container 108 without force. Such an embodiment may be advantageous for a task requiring the person to handle the third container 108 and squeeze the third container 108 to transfer the fluid therein to another container, for example, the second container 106. The third container 108 (e.g., a bottle) is preferably capable of holding eight ounces (8 oz.), but may hold more or less in other embodiments. FIG. 1E depicts plates 110 which may be employed for holding objects, such as bean bags 112 (FIG. 1F) representing the weight of food. Moreover, a knife and fork (not shown) may be used with the plate 110 and either with real food or a food substitute (representing the texture, thickness, and/or durability of food) to test gripping and maneuverability abilities of the patient with the prosthetic device.

Further objects that may be used when testing prosthetics include a shoe 114 (FIG. 1G), for example, to test time and ability to tie the shoe laces. FIG. 1H is an enlarged picture of dice 116 that may be employed to test the patient's ability to grasp and maneuver small objects. Alternatively, the dice 116 may be used in combination with other objects to test the patient's use of the prosthesis. For example, the patient may be tasked with picking up one or more dice 116 and placing such on the plate 110, and thereafter picking up the plate 110 and moving the plate 110 from a first location (e.g., a table) to a second location (e.g., a shelf). In some embodiments, the dice 116 may be ⅝″ in size. However, one of skill in the art will appreciate sizes smaller and larger than ⅝″ may be employed and are contemplated herein.

FIG. 1I depicts one embodiment of a multi-purpose test fixture 118. The test fixture 118 includes a door 120 that may require opening, a thin slot 122 for which coins or other thin objects may be required to be placed within, and a knob or handle 124 coupled to the test fixture 118 and configured to rotate. Additional items which may be employed to perform the various tasks which test a patient's ability to use their prosthesis include, but are not limited to, a picture frame and frame stand, measuring tape, Theraputty, and an article of clothing which includes a zipper. Exemplary uses for some of these items may include where the patient is tasked with placing the picture frame on and/or off of the frame stand, or is tasked with wearing the article of clothing and zipping and/or unzipping the clothing zipper.

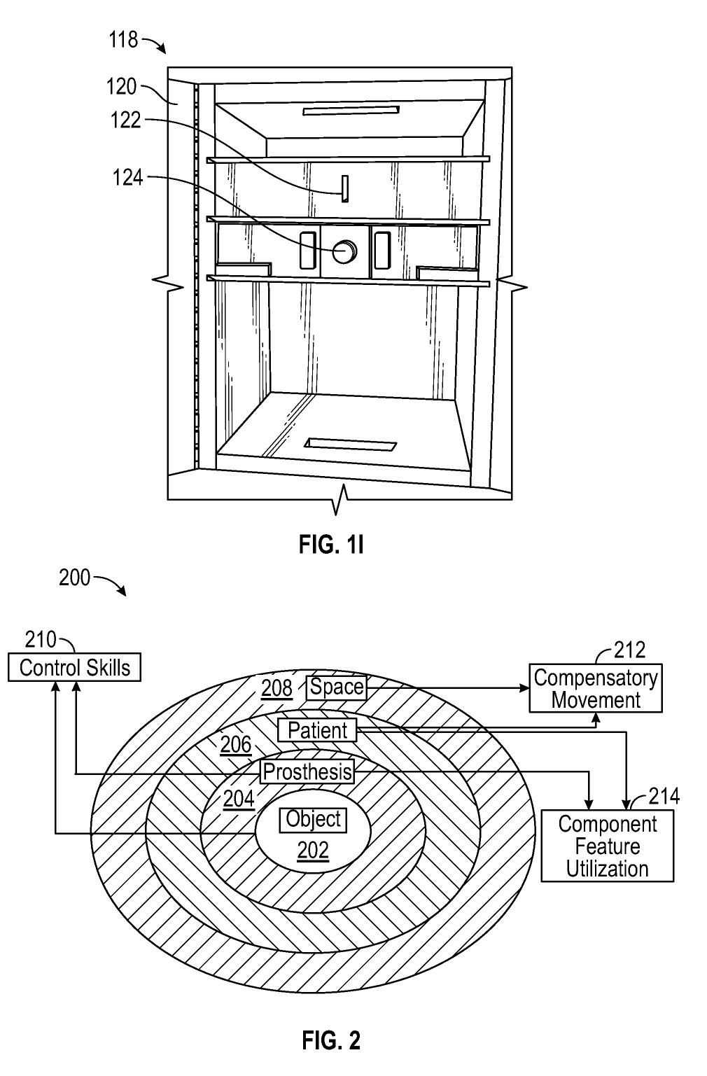

FIG. 2 is a diagram 200 depicting factors associated with scoring criteria for each task, according to one or more embodiments. The diagram 200 includes encompassing areas representing an object 202 to be handled by the prosthesis 204, the prosthesis 204 itself, the patient 206, and the space 208 in which the patient moves or uses the object 202. The diagram 200 also depicts some of the scoring categories for each task to be completed, such as control skills 210, compensatory movement 212, and component feature utilization 214, and the primary factors associated with scoring each of the scoring criteria.

The control skills category 210 represents how well the patient can control and/or operate the prosthesis to manipulate an object and perform a task. For example, observing over- and under-shooting intended positions when attempting to grasp, move, and release objects, readjustment of grip, and/or uncontrolled drops of the object. The diagram 200 illustrates the primary factors for determining a control skills 210 score may be the prosthesis 204 and the object 202. The component feature utilization category 214 represents the patient's ability to utilize the component features of the prosthesis for optimal interaction between the prosthesis and the object being manipulated. Scoring may depend on observations of non-utilization or mis-utilization of the prosthesis components to perform tasks in a manner most like the performance of an intact sound limb. Thus, the diagram 200 illustrates primary factors for determining component feature utilization 214 may be the patient 206 and the prosthesis 204. The compensatory movement 212 category represents the effect of the prosthesis on the patient's physical movement in space. For example, instead of a patient simply moving their wrist to accomplish a task, the entire arm may be moved. Thus, the primary factors for determining compensatory movement 212 may include the patient 206 and space 208.

It will be appreciated by those skilled in the art that the category descriptions and primary factors are merely examples of such, but should not be interpreted as limiting. Moreover, additional categories observed and/or scored for each task may include task completion—if the patient was able to complete the task or not, and time required to complete the task.

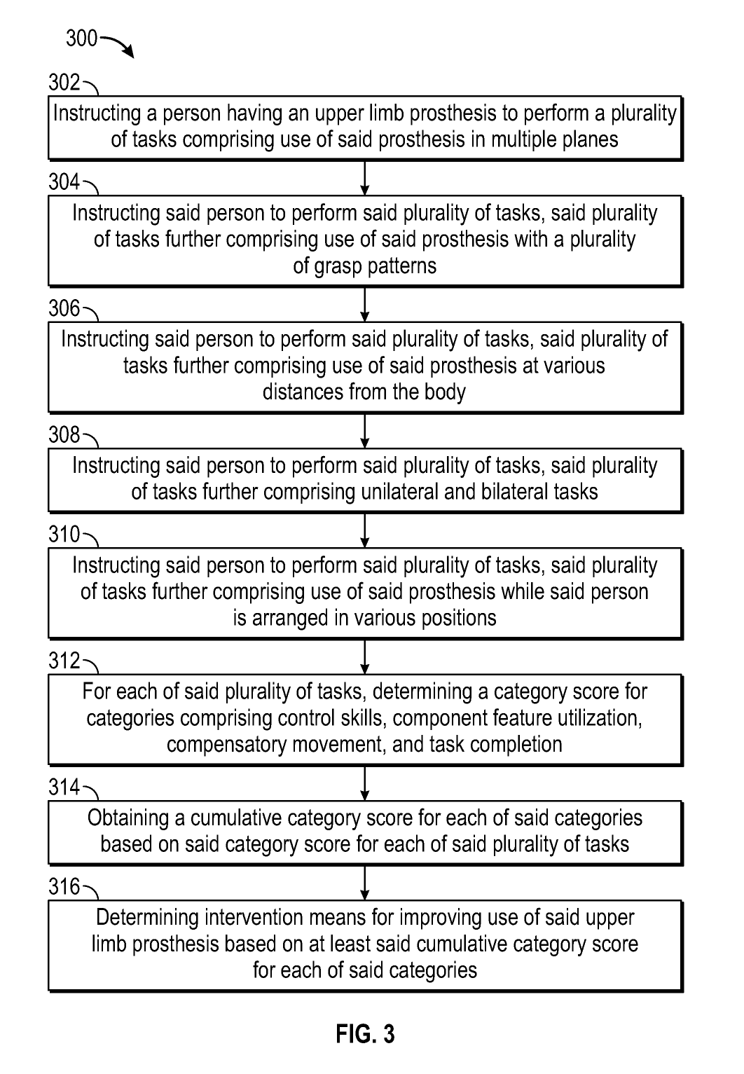

FIG. 3 is a flow diagram of a method 300 for determining an intervention means to improve use of the upper limb prosthesis by the patient. At block 302, the patient having an upper limb prosthesis is instructed to perform a plurality of tasks that include use of the prosthesis in multiple planes. In one embodiment, as known to those skilled in the art, such planes may include the three anatomical planes which pass through the body, including the sagittal plane which divides the body into left and right sides, the frontal plane which divides the body into front (anterior) and back (posterior) portions, and the transverse plane which divides the body into upper (superior) and lower (inferior) portions. Thus, for example, a first task may require moving the dice from one side of the body to another, whereas a second task may require moving a plate from a table to a shelf at a height above the table, thus employing use in the sagittal and transverse planes.

At block 304, the patient is instructed to perform the plurality of tasks which use the prosthesis with a plurality of grasp patterns. As known to those skilled in the art, such grasp patterns may include, but are not limited to, power grasps such as a cylindrical (e.g., grasping a bat), spherical (e.g., grasping a ball), hook (e.g., grasping a suitcase), or conoid grasp (e.g., for knives, forks, and tools). Such grasp patterns may further include prehension gasps, such as three jaw chuck or tripod grasp (e.g., to pick up a block), a tip or pincer grasp (e.g., to pick up a pin), and/or a lateral-prehension or grip (e.g., to pick up paper or a key).

At block 306, the patient is instructed to perform the plurality of tasks using the prosthesis at various distances from the body. One task which may demonstrate such, for example and without limitation, using the prosthesis to pick up a die from a table and touch the patients nose or chin with the die. Such a task illustrates use of the prosthesis at a distance medium to far from the patient (picking up the die off the table) and close to the patient (touching the die to the patient's chin).

At block 308, the patient is instructed to perform the plurality of tasks which include unilateral and bilateral tasks. Unilateral tasks are tasks which employ only the prosthetic to perform an action, for example, picking up a die from a table and placing the die on a plate. Bilateral tasks employ both the prosthetic and the patient's other hand (which may be natural, or may be a second prosthesis). One example of a bilateral task is tying shoe laces of a shoe. Another example may be picking up a container (with or without another object therein) by the container handles and moving the container to a predetermined location.

At block 310, the patient is instructed to perform the plurality of tasks which require the patient to be arranged in various positions. For example and without limitation, such positions may include while the patient is seated (e.g., moving one or more die from a table top to a plate arranged on the table), and/or while the patient is standing (e.g., standing while turning the handle 124 of the text fixture 118).

It will be appreciated that each task of the plurality of tasks may incorporate one or more of the blocks 302, 304, 306, 308, and 310. In some embodiments, the plurality of tasks may include picking up a weight with the prosthesis and placing the weight within a hollow area of a first container having a bottom and a pair of handles. The task may alternatively or additionally require picking up the first container, likely in a bilateral fashion via the first container handles, and walking the first container a predetermined distance to a second location, wherein the container is placed down. Moreover, the task may further require picking the first container up for a second time and walking the first container from the second location back to the first location.

In further embodiments, the plurality of tasks may additionally or alternatively include picking up a die from a first surface (e.g., a table) with the prosthesis, raising the die to the patient's chin, and placing the die back on the table. In further embodiments, such may be repeated additional times, either with the same or a different die. In other embodiments, the plurality of tasks may additionally or alternatively include tying shoe laces of a shoe when arranged on the patient's foot. Typically, the shoe is on the foot on the same side of the body as the prosthesis and the laces are tied while the patient is in a sitting position. In one embodiment, the shoe may be arranged on a stool or an inclined portion of a fixture, wherein the incline is sloped upwards and away from the patient and the fixture places the shoe at a predetermined height. In even further embodiments, the plurality of tasks may include picking up a plate from a table while in a standing position and placing the plate on a shelf arrange at a height greater than the table. In one embodiment, one or more die may be arranged on the plate while performing the task.

In other embodiments, the plurality of tasks may require the patient to hold a knife with the prosthesis and a fork with their other hand, and further require cutting an object with the knife. The object may be real food, or may be a substance resembling the texture and/or density of food, such as a putty.

In further embodiments, the plurality of tasks may additionally or alternatively include having a second container, such as a cup, and a third container, such as a water bottle, and being required to transfer liquid from the third container to the second container. In one embodiment, the third container (water bottle) may include a top that substantially prevents the liquid from being removed without force, thereby requiring the patient to both hold and squeeze the water bottle to remove the liquid and complete the task. Moreover, the patient may be required to empty the third container, thereby requiring multiple distinct squeezes.

Some embodiments may include tasks employing a test fixture which includes a thin slot to place objects through and a handle mounted to the test fixture and capable of rotating. The task may require the patient to pick up one or more coins or other similarly thin objects and place them into the slot one at a time. Alternatively or additionally, the patient may be required to rotate the handle a predetermined amount in a first direction (e.g., in the clockwise direction), and then rotating the knob in the opposite direction (e.g., counter-clockwise) until the knob is returned to the starting position. Moreover, further tasks may require picking up weights with the prosthesis from a table and placing the weights on top of the test fixture, and/or moving the weights from the top of the test fixture to the table.

Other tasks may include picking up a frame (e.g., a picture frame) from a tabletop and place it onto a frame holder, and then further removing the frame from the frame holder and place it back on the tabletop. Moreover, such may be performed either unilaterally or bilaterally. In further embodiments, the plurality of tasks may additionally or alternatively include having the patient wear a piece of clothing which includes a zipper, and having the patient zip the zipper up and down with the prosthesis. Advantageously, such tests simulate real life tasks, thereby enabling proper intervention.

At block 312, a category score is determined for each of the plurality of tasks, wherein the categories include control skills, component feature utilization, compensatory movement, and task completion as discussed above. Table 1 below depicts one example of a scoring chart resembling such.

TABLE 1

| | | Component | | |
|---|---|---|---|---|
| | Control | Feature | Compensatory | Task |
| | Skills | Utilization | Movement | Completion |
| Task 1 | 2 | 0 | 4 | 4 |
| Task 2 | 4 | 0 | 4 | 4 |
| Task 3 | 2 | 1 | 3 | 4 |
| Cumulative | 8 | 1 | 11 | 12 |
| Category Score | | | | |

Table 1 includes each of the described categories. The categories may be scored in any of a variety of manners, including alphabetic or numeric (increasing, decreasing, linear, non-linear, etc.) scoring, or a combination thereof. As depicted, the control skills category employs a numeric range from 0 (unable to grasp) to 4 (satisfactory control), the component feature utilization category employs a numeric range from 0 (unable to use component features) to 4 (all component features used appropriately), the compensatory movement category employs a numeric range from 0 (abnormal movement) to 4 (normal posture), and the task completion category employs a numeric range from 0 (unable to complete task) to 4 (completed task successfully).

The plurality of tasks in Table 1 included three tasks, and each category was scored for each of the plurality of tasks. Moreover, Table 1 further depicts a Cumulative Category Score for each of the categories which accumulates (in this example, by addition) the score for each task for an individual category. As depicted, Table 1 indicates a deficiency in the patient's use of the prosthetic component features, thus a therapist may employ an intervention which focuses on and corrects such.

The category score may be determined via a category scoring means, for example and without limitation, by pencil and paper or by a computer having a program capable of determining such cumulative category scores based on the category score for each category of each task. The computer may include components such as, but not limited to, one or more processors, volatile and/or non-volatile random access memory (RAM), a hard drive, and user inputs (e.g., a keyboard and mouse) and outputs (e.g., a monitor and/or printer). The computer may store results from a first plurality of tasks, thereby allowing recall in the future. In some embodiments, when determining the assessment of the prosthetic, the computer program may incorporate results from various sets of tasks performed over a period of time. The program may indicate measurements or statistics of the patient which have changed and/or remained constant for the patient over the period of time, thereby possibly indicating if certain therapy interventions are working or if other interventions should be introduced in the patient's treatment.

At block 314, intervention means are determined based on at least the cumulative category score for each of said categories. In some embodiments, the intervention means may further be based on the individual category scores for each task. In other words, more particularized intervention may be possible by also looking at the category scores for each of task 1, task 3, and task 3 in combination with the cumulative category scores. Such intervention means may include, but are not limited to, modifying the prosthetic fit to the patient, modifying prosthetic design or suspension type, and/or modifying a practice or training regimen which teaches the patient how to better use the prosthetic, including better use of the prosthetic feature. Moreover, such tests may be repeated after a period of time (e.g., a week, month, year, etc.) in order to evaluate progress and/or determine a second intervention means necessary to continue progress and increase use ability of the prosthetic. In some embodiments, such intervention may be determined by an intervention determination means, for example and without limitation, the computer discussed herein and/or charts or flow diagrams incorporating the principles discussed herein regarding the scoring categories and results thereof determining the necessary intervention.

Advantageously, such intervention maximizes a patient's rehabilitation potential. Moreover, such task scores and intervention can be used to develop trend analysis to develop best practices, may be distributed to insurance companies as objective data and justification for rehabilitation plans and reimbursement, identify and address performance obstacles early in the continuum of care, and to track changes in performance and address intervention accordingly.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein.

Also, the terms in the claims have their plain, ordinary meaning unless otherwise explicitly and clearly defined by the patentee. Moreover, the articles “a” or “an,” as used in the claims, are defined herein to mean one or more than one of the element that it introduces. As used herein the term “and/or” and “/” includes any and all combinations of one or more of the associated listed items. While compositions and methods are described in terms of “comprising,” “containing,” or “including” various components or steps, the compositions and methods can also “consist essentially of” or “consist of” the various components and steps.

It will be understood that the sizes and relative orientations of the illustrated elements are not shown to scale, and in some instances they have been reduced or exaggerated for purposes of explanation. Additionally, if there is any conflict in the usages of a word or term in this specification and one or more patent or other documents that may be incorporated herein by reference, the definitions that are consistent with this specification should be adopted.

What is claimed is:

1. A method for determining an intervention to improve use of upper limb prosthesis, comprising:
instructing a person having an upper limb prosthesis to perform a plurality of tasks comprising use of said prosthesis in multiple planes;
instructing said person to perform said plurality of tasks, said plurality of tasks further comprising use of said prosthesis with a plurality of grasp patterns;
instructing said person to perform said plurality of tasks, said plurality of tasks further comprising use of said prosthesis at various distances from the body;
instructing said person to perform said plurality of tasks, said plurality of tasks further comprising unilateral and bilateral tasks;
instructing said person to perform said plurality of tasks, said plurality of tasks further comprising use of said prosthesis while said person is arranged in various positions;
for each of said plurality of tasks, determining a category score for categories comprising control skills, component feature utilization, compensatory movement, and task completion;
obtaining a cumulative category score for each of said categories based on said category score for each of said plurality of tasks; and
determining intervention means for improving use of said upper limb prosthesis based on at least said cumulative category score for each of said categories.

2. The method of claim 1, wherein, for each of said plurality of tasks, said categories further comprise a completion time.

3. The method of claim 1, wherein said determining intervention means further comprises being based on said category score of each of said plurality of tasks.

4. The method of claim 1, wherein use of said prosthesis in multiple planes comprises use in a transverse plane, sagittal plane, and frontal plane.

5. The method of claim 1, wherein said plurality of grasp patterns includes at least one of a cylindrical, spherical, hook, conoid, three jaw chuck, tip, pincer, and lateral-prehension.

6. The method of claim 1, wherein use of said prosthesis while said person is arranged in various positions comprises use in a standing position and use in a seated position.

7. The method of claim 1, wherein said intervention means comprises modifying a fit of said prosthesis to said person.

8. The method of claim 1, wherein said intervention means comprises training said person how to use said prosthesis.

9. The method of claim 1, wherein said plurality of tasks comprises at least one of:
picking up a weight with said prosthesis and placing said weight within a hollow area of a first container having a bottom and a pair of handles;
picking up said first container from a first location via said pair of handles and walking a predetermined distance to a second location, placing said first container down at said second location, picking up said first container from said second location via said pair of handles and walking said predetermined distance back to said first location, and placing said first container down at said first location;
picking up a first die from a table with said prosthesis, raising said first die to said person's chin, and placing said first die back on said table, picking up a second die from a table with said prosthesis, raising said second die to said person's chin, and placing said second die back on said table, picking up a third die from a table with said prosthesis, raising said third die to said person's chin, and placing said third die back on said table;
tying shoes laces of a shoe arranged on a foot on the same side of said person's body as said prosthesis while in a sitting position;
while in a standing position, picking up a plate from said table, wherein a plurality of die are arranged thereon, placing said plate on a shelf arranged a height greater than said table, picking up said plate from said shelf and placing said plate on said table;
cutting an object with a knife held by said prosthesis and a fork held by said person's second hand;
picking up a second container with said prosthesis, said second container having a fluid arranged therein and a top coupled thereto which substantially prevents removal of said fluid without force, and squeezing said second container thereby forcing removal of said fluid therefrom into a third container;
grasping a handle with said prosthesis, said handle coupled to a test fixture and configured to rotate, and rotating said handle in a first direction a predetermined rotation quantity, thereafter rotating said handle in a second direction opposite the first direction in said predetermined rotation quantity;
picking up a coin with said prosthesis and placing said coin into a coin slot coupled to said test fixture;
picking up said picture frame from said table with a bilateral grasp, placing said picture frame on a picture frame stand arranged on said shelf, picking up said picture frame from said picture frame stand with said bilateral grasp and placing said picture frame on said table;

10. The method of claim 1, further comprising:
performing said plurality of tasks a second time after a predetermined period of time;
for each of said plurality of tasks, determining a second category score for categories comprising control skills, component feature utilization, compensatory movement, and task completion;
obtaining a second cumulative category score for each of said categories based on said second category score for each of said plurality of tasks;
determining second intervention means for improving use of said upper limb prosthesis based on at least said second cumulative category score for each of said categories.

11. A system for determining an intervention to improve use of upper limb prosthesis, comprising:
task means for performing a plurality of tasks which test the ability of a person having an upper limb prosthesis to use said upper limb prosthesis in multiple planes, with a plurality of grasp patterns, at various distances from the body, in performing unilateral and bilateral tasks, and while said person is arranged in various positions;
category scoring means for determining a category score for categories comprising control skills, component feature utilization, compensatory movement, and task completion, said category score for said categories being determined for each of said plurality of tasks; and
intervention determination means for determining an intervention to improve use of said upper limb prosthesis based on at least a cumulative category score of each of said categories.

12. The system of claim 11, wherein, for each of said plurality of tasks, said categories further comprise a completion time.

13. The system of claim 11, wherein said intervention determination means further comprises being based on said category score of each of said plurality of tasks.

14. The system of claim 11, wherein said multiple planes comprises a transverse plane, sagittal plane, and frontal plane.

15. The system of claim 11, wherein said plurality of grasp patterns includes at least one of a cylindrical, spherical, hook, conoid, three jaw chuck, tip, pincer, and lateral-prehension.

16. The system of claim 11, wherein said various positions comprises a standing position and use in a seated position.

17. The system of claim 11, wherein said task means comprises at least one of:
a weight and a first container having a bottom and a pair of handles;
a plurality of die;
a shoe having shoe laces;
a table, a plate, and a shelf arranged at a height greater than said table;
a knife, a fork, and an object capable of being cut with said knife;
a second container having a fluid arranged therein and a top coupled thereto which substantially prevents removal of said fluid without force, and a third container;
a test fixture comprising a handle coupled thereto and configured to rotate, said test fixture further comprising a coin slot, wherein said system further comprises a coin to be placed into said coin slot; and
a picture frame and picture frame stand configured to hold said picture frame.
